(19) United States
(12) Patent Application Publication
(10) Pub. No.: US 2015/0066602 A1
(43) Pub. Date: Mar. 5, 2015

(54) METHOD AND DEVICE FOR UTILIZING QUALITATIVE RATINGS TO EVALUATE MEETINGS

(71) Applicant: John Windsor, Boulder, CO (US)

(72) Inventor: John Windsor, Boulder, CO (US)

(73) Assignee: PEAKAPPS, INC., Boulder, CO (US)

(21) Appl. No.: 14/012,010

(22) Filed: Aug. 28, 2013

(51) Int. Cl. G06Q 10/06

(52) U.S. Cl. CPC G06Q 10/06393
USPC 705/7.39

(57) ABSTRACT

A method and electronic device for rating a meeting using qualitative data includes providing a processor, a memory, a network interface and a user interface in operable communication with the processor, and the electronic device is programmed with software including a calendar. The electronic device is programmed to perform the steps of, scheduling a meeting including a list of attendees, after scheduling the meeting, displaying a set of evaluation criteria on the user interface, including displaying a slider bar for each criterion, the slider bar being labeled with indicia having a value. Next the method includes displaying a sliding indicator on each slider bar, and enabling a user to select a value on each slider bar. Summing the selected values for each slider bar to determining an aggregate value and the aggregate value is used to rate the meeting using qualitative data. Output is provided in a dashboard format.

### FIELD OF THE INVENTION

The invention relates to meeting productivity analytics, and particularly to ways of evaluating meetings.

### BACKGROUND OF THE INVENTION

Most personal computers, networked systems, email systems and hand-held devices are capable of displaying a calendar function for scheduling meetings, along with note-taking capabilities supplied by any number of software developers. Meetings are conducted face-to-face, telephonically, or via electronic media. It is not uncommon to hold a meeting where some attendees are in person, some participate via a telephone, and others participate via video conference systems.

Numerous ways to gather data for analyzing relationships and meetings are known. For example, U.S. Pat. No. 8,117,136 to Yang describes a way to integrate data from various sources including text messages, phone calls and emails to enable relationship management. While this system is good for managing relationships using objective criteria such as entity name, contact frequency and event and task information from disparate sources, it does not teach an effective way of integrating the objective (quantitative) data criteria with subjective (qualitative) criteria derived from users of the system.

European Patent Application No. 0 475 871 A2 to Hager et al. describes a system for evaluating documents by many people, and collects qualitative data from the participants in the evaluation process. Attendee names are compiled, meeting parameters proposed, documents are automatically shared and an evaluation mechanism is provided to evaluate the documents that are shared. Quantitative data such as meeting times and durations are included in the system. Both quantitative and qualitative data is circulated to attendees.

U.S. Patent Publication No: US2006/0293943 A1 to Tishhauser et al. describes software that enables the automatic scheduling of meetings. A user enters the names of attendees and a computer determines suggested meeting times based on quantitative data pertaining to electronic calendar for each attendee. Interestingly, the computer identifies suggested meeting times based on the category of the meeting and other priorities. This invention helps people find appropriate times and places to meet.

Those that attend many meetings realize that some meetings are better than others. Objective criteria such as whether the meeting went over time, or completed at the scheduled time, is not enough to determine whether the meeting was a success. There is a need for a more effective way of evaluating meeting productivity and results. What is desired is a way of knowing whether or not meetings are successful, effective, and productive so that future meetings can benefit from this knowledge.

### SUMMARY OF THE INVENTION

The present invention includes a method for using quantitative and qualitative data pertaining to meetings to improve the meeting process. This includes providing meeting preparation and tracking software for scheduling meetings and gathering qualitative and quantitative data from the meetings. Combining the quantitative and qualitative data enables analysis of the quality of any meeting, and enables a consistent comparison across a set of meetings.

The quantitative data includes time, duration, agenda, actions, project type, attendee number and role, and other things. Quantitative data also includes attributes of the meeting presenter, including role (i.e. sales manager, project manager, executive, etc.), and the subject of the meeting (i.e. sales, financials, production, logistics, etc.). The quantitative data can be gathered from a calendar, a project management database, a financial database, a relationship management database, human resources records, and many other data sources. The present invention integrates useful data from these quantitative data sources and makes it available to combine with qualitative data derived by the present invention.

The qualitative data is derived from a unique attendee survey mechanism. Accordingly, the quantitative data are combined with qualitative data gathered from attendee input to enable optimal analysis.

Preferably, the qualitative data are gathered from a questionnaire presented in electronic form to an attendee. The questionnaire provides simple predetermined criteria including goal, agenda, preparation, process and outcome. The questionnaire is preferably presented with sliding indicators yielding a numerical range. The numerical range can be from −2 to +2, or −1 to +1, for example, depending on the weighting of a given element. This yields a total numerical aggregate value attributable to the meeting, from 0 to 10, which is a subjective or qualitative value for the effectiveness of the meeting, according to the subjective view of an attendee.

The qualitative value for each meeting's effectiveness can be analyzed for particular attendees, for presenters, and for groups of attendees with an eye towards maximizing organizational goals. These qualitative data can be combined with quantitative data for further analysis. This process can be applied for a series of meetings having a particular subject, for type of meeting (such as problem solving, planning, or brainstorming ideas), for time of day, for day of the week, or for all meetings conducted over a particular time period. Optimal analysis can yield knowledge about the effectiveness of particular meeting subjects, types, attendees, presenters, and for organizations under which the attendees operate.

Accordingly the present invention includes a method of rating a meeting using qualitative data and quantitative data to evaluate a meeting. The method includes providing an electronic device, having a processor, memory, a network interface and a user interface, in operable communication with the processor, the electronic device being programmed with software. Next, the method includes scheduling a meeting, including a list of attendees, and providing frameworks for planning the meeting. The attendees then conduct the meeting. This can be accomplished in person, or via electronic means. Electronic means includes telephone, video conference or computer based meetings that include file sharing, voice and video.

In one embodiment, only qualitative data derived from the survey is used to rate meetings.

During a meeting, or at the end of the meeting, the method involves conducting a survey to evaluate the meeting. This includes providing a meeting evaluation interface to the attendees and displaying a set of evaluation criteria on the user interface. This evaluation criterion is pre-determined. The method displays a slider bar for each evaluation criteria on the electronic device of a meeting attendee. The slider bar is labeled with indicia having a value, such as an alpha-numeric value. Next the method displays a sliding indicator on each slider bar. The electronic device interface displays an indicator which is slid by contacting the interface with a digit of a user or by using a computer mouse. The user is thus enabled to select a value on each slider bar to simply and quickly apply a selected value, which yields a qualitative rating to the selected criteria. Summing the selected values for each slider bar is used to determine an aggregate value, and the meeting is rated using the aggregate value in a range of 0 to 10, which represents a qualitative rating for the meeting. This qualitative rating can be combined with quantitative data to provide useful insights that can make future meetings more productive and effective.

### BRIEF DESCRIPTION OF THE DRAWINGS

Examples of the present invention are shown in the drawings, where like reference numerals indicate like elements and in which:

FIG. 1 is a diagram of a system in accordance with the present invention.

FIG. 2 is a flow chart of a method in accordance with the present invention.

FIG. 3 is a system diagram of a client device used in the system of FIG. 1.

FIG. 4 is a flow chart of a method of displaying evaluation criteria in accordance with the present invention.

FIG. 5 is a screen shot of a ratings interface in accordance with the present invention.

FIG. 6 is a screen shot of a ratings interface in accordance with the present invention.

FIG. 7 is a screen shot of a ratings interface in accordance with the present invention.

FIG. 8 is a screen shot of a ratings interface in accordance with the present invention.

FIG. 9 is a screen shot of a dashboard that compiles and displays various output derived from the ratings and evaluation thereof.

### DETAILED DESCRIPTION

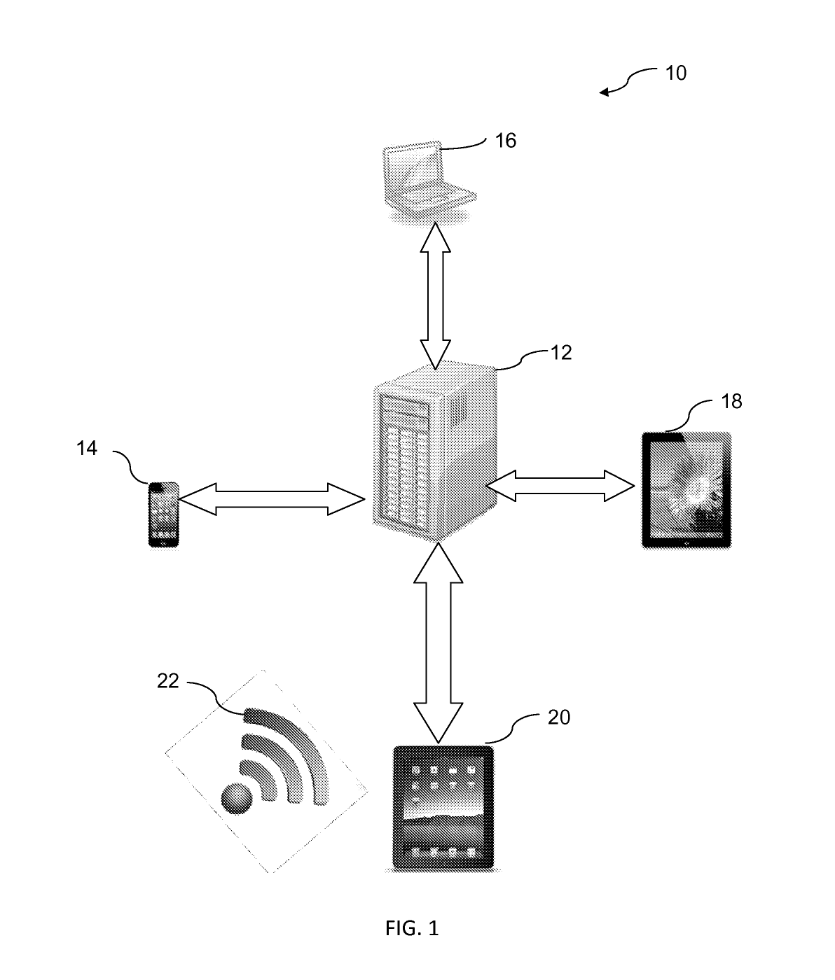

FIG. 1 shows an example of a system, generally designated with the reference numeral 10, in accordance with the present invention. The system 10 includes a server 12. The server 12 is a network server capable of maintaining various networked applications including a calendar which can be synchronized from numerous client workstations. The system 10, thus, includes client workstations 14, 16, 18, and 20. The client workstation 14 represents a smart phone. The client workstation 16 represents a personal computer such as a laptop computer, and the laptop computer can include an input device such as a mouse. The client workstations 18 and 20 represent tablet computers. The server 12 and the client workstations 14, 16, 18, and 20 communicate via a network signal 22. In an alternate embodiment, communication can be via a wire4d Ethernet connection.

In an alternate embodiment, the network signal is communicated wirelessly. The network signal 22 can include an 802.11x-type protocol, or include cellular signals routed via a cellular network having, for example, a 4G protocol.

Each client workstation device 14, 16, 18 and 20 is preferably programmed with an application for rating meetings using both quantitative and qualitative data. The application for rating meetings is integrated into a calendar application in one embodiment of the invention. In an alternate embodiment, the application is a stand-alone application for planning, conducting and following up on meetings. In a further embodiment, the stand-alone application is an integrated as a plug-in to an existing calendar, such as Google Calendar™, the ICal™, by Apple, Inc., or any other suitable calendar. Accordingly, the application shares and exchanges data with a user calendar.

The application is, in one embodiment of the invention, stored and run locally on each workstation device 14, 16, 18 and 20. A component of the application for rating meetings is also stored and operated on the server 12. The server 12 enables processing of qualitative data provided by each workstation device 14, 16, 18 and 20. The server 12 integrates the qualitative data provided with quantitative data such as date, time, and duration of meetings. The server 12 integrates quantitative data with the quantitative data. The quantitative data, for example, includes histories of other meetings, organizational roles of attendees and history of meetings for each attendee, purpose and subject matter of the meetings, and calculated ratings of prior meetings. Any useful quantitative data can be used.

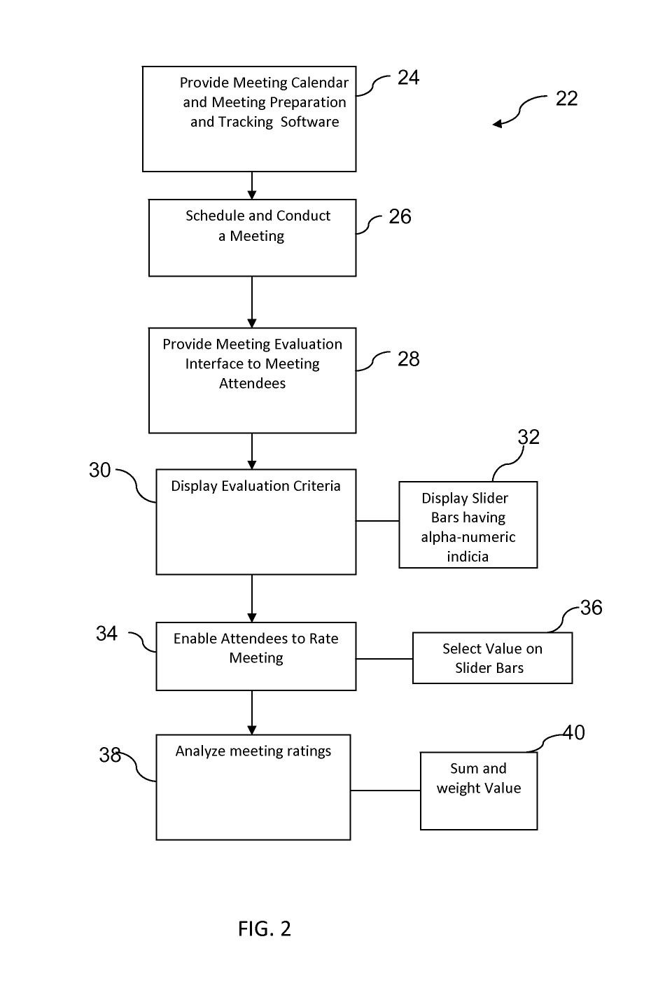

FIG. 2 shows a flowchart of a method 22 in accordance with the present invention. The method 22 includes the step 24 of providing a meeting calendar and providing meeting preparation and tracking software. The meeting tracking software is implemented on hardware designed to run the meeting tracking software.

The method 22 also includes the step 26 of scheduling and conducting a meeting, which includes providing user instructions for preparing for and conducting the meeting to attendees and to presenters. In one embodiment the step 26 records notes and follow-up actions. In an alternate embodiment, the meeting time and duration in the calendar application is stored on a number of client workstation devices and on the server 12 of FIG. 1.

The method 22 also includes the step 28 of providing a meeting evaluation interface which meeting attendees use to evaluate the effectiveness of the meeting. In one embodiment the step 28 also includes providing a meeting evaluation interface to a meeting presenter.

In one embodiment the evaluation interface is programmed in software and is a stand-alone application that is configured to communicate with an existing calendar application. Such communication may be as simple as pulling data from the calendar application including meeting times and attendees. In a more complex variation of the invention, the evaluation interface is configured as a plug-in to an existing calendar.

In an alternate embodiment the meeting evaluation interface is programmed on a separate application.

In a further embodiment, the evaluation interface is programmed in software that includes a calendar application. Accordingly, meeting preparation and management applications are modules working in the same environment as a calendar application.

The meeting evaluation interface is stored locally on each client workstation device and on the server 12 of FIG. 1. In an alternate embodiment, the meeting evaluation interface and associated data is stored centrally, i.e. on the server, and then displayed on client devices, which communicate with the server.

The step 30 displays evaluation criteria on each client workstation. The step 30 may be automated to pop up at the scheduled termination time of any calendar meeting. In another embodiment the step 30 is initiated by a meeting attendee operating client workstation by manually selecting the meeting evaluation application. In a preferred embodiment the step 30 includes the step 32 of displaying slider bars having alpha-numeric indicia. The slider bars include an indicator that can be slid along each slider bar by movement of the finger dragging across the interface, or utilizing a mouse.

The step 34 enables attendees to rate the meeting. Enabling attendees to rate the meeting includes the step 36 of selecting a value on the slider bars. Typically this involves sliding the indicator along each slider bar.

The step 38 analyzes meeting ratings. The step 38 particularly involves the step 40 of summing the values selected on the slider bars having alpha-numeric indicia. In the case of numerical indicia mathematical sum yields an aggregate value. In the case of alpha indicia, the elf indicia can be converted into numerical values where the numerical sum yields an aggregate value. The aggregate value can be utilized to achieve evaluation of the meeting and when compared to the value of other meetings can achieve the rank for the meeting or for various criteria upon which the meeting is evaluated.

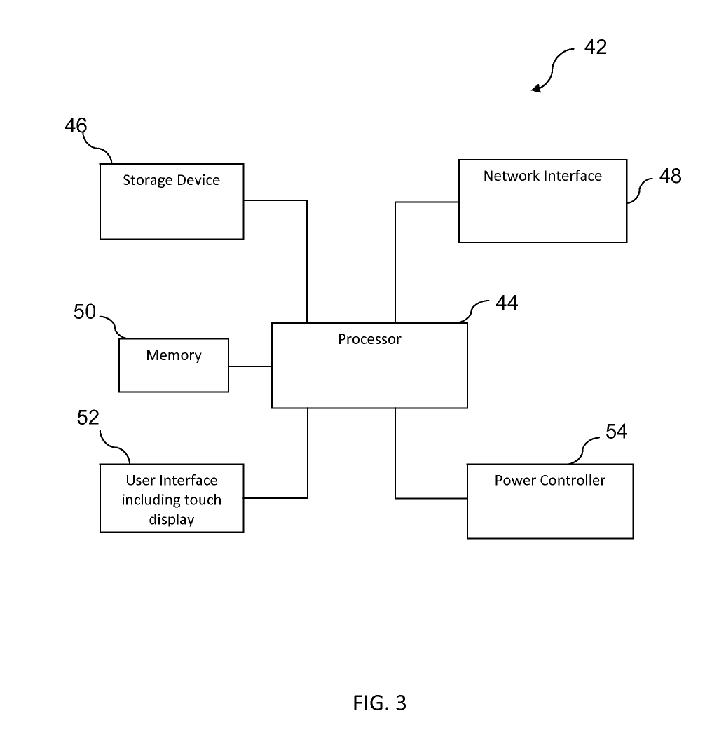

FIG. 3 shows a system diagram generally designated with the reference numeral 42. The system 42 is typical of systems employed by each client workstation device shown in FIG. 1. The system 42 includes a processor 44, a storage device 46 an network interface 48 a memory 50 a user interface, which may include a touch display on mobile devices 52, and the power controller 54, all connected in operative communication.

The user interface 52 is preferably a multi-touch display to enable a user such as a meeting participant to slide the indicator along the slider bar to evaluate specific criterion of the meeting. In an alternate embodiment the user interface 52 includes a standard TOC or LCD display and a mouse or touchpad to enable the user or meeting participant to slide the indicator along the slider bar.

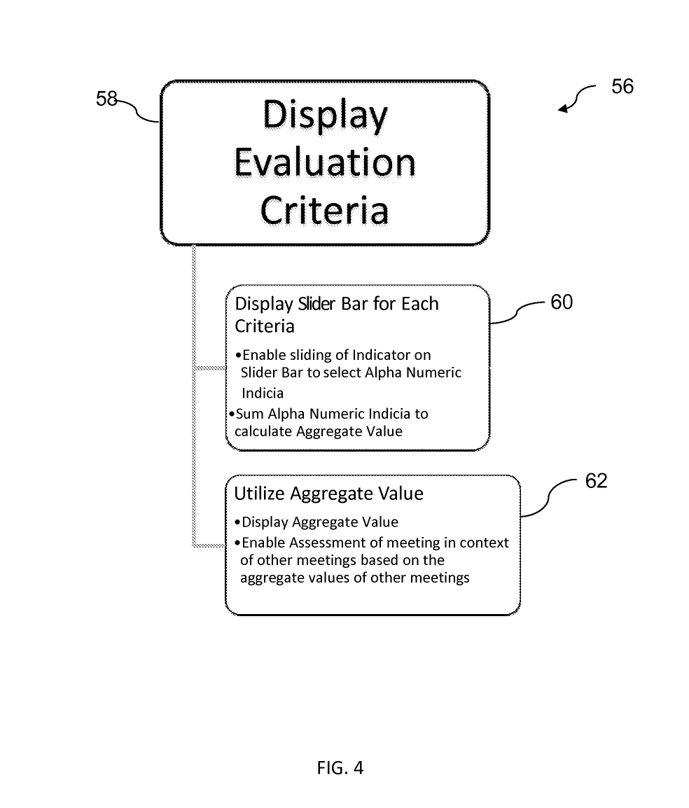

FIG. 4 shows a flowchart of a method generally designated with the reference numeral 56. The method 56 includes the step 58 of displaying the evaluation criteria. The step 58 includes the step 60 of displaying a slider bar for each criterion, and the step 62 of calculating an aggregate value for the criteria.

The step 60 further includes enabling sliding of an indicator to select indicia. The indicia can be alphanumeric, but are preferably numeric indicia. The step 60 also includes summing the indicia to calculate the aggregate value. The step 62 of calculating the aggregate value displays the aggregate value to the meeting attendee or user of the client workstation. The step 62 of calculating the aggregate value further includes enabling assessment of the meeting in context of other meetings based on the aggregate values of numerous meetings. In this way the subjective views of meeting participants can be compiled compared and evaluated over the course of numerous meetings. The subjective views of meeting dispenses also reduce to a simple qualitative rating. This qualitative rating can be combined and manipulated with quantitative data to provide a desired analysis of all data surrounding the meeting and any series of meetings orchestrated by a single organization multiple organizations for a particular topic or multiple topics.

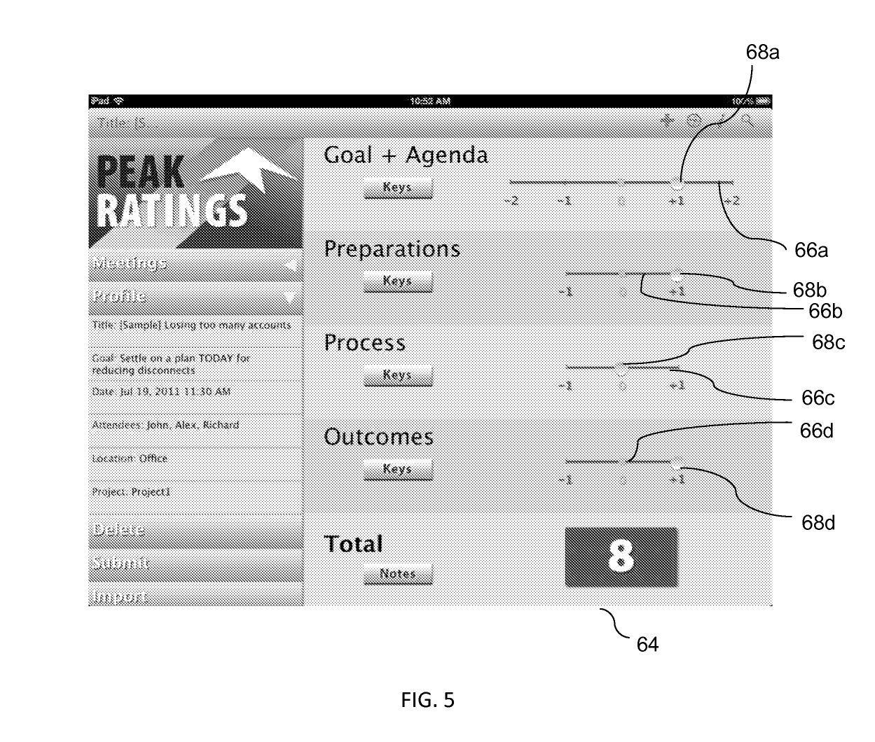

FIG. 5 shows a user interface screen 64 having a set of slider bars 66a, 66b, 66c and 66d. The slider bar 66a is labeled GOAL+AGENDA and includes a range of numeric values from −2 to +2. An indicator 68a is positioned above the numerical value+1. The indicator 68a is slideable along the slider bar 66a to select a value of between −2 to +2. Preferably the screen 64 is a touch screen that enables a digit of a human hand to slide the indicator 66a. In an alternate embodiment, the screen 64 is communicates with a mouse device to slide the indicator 66a.

The slider bar 66b is labeled PREPARATIONS and includes an indicator 68b positioned above the numerical value+1. The slider bar 66c is labeled PROCESS and includes an indicator 68c above the numerical value zero (0). The slider bar 66d is labeled OUTCOMES and includes an indicator 68d above the numerical value+1.

The GOAL+AGENDA criterion is deemed most important. This is associated with a broader value range, up to +/−2 than the other criteria. GOAL+AGENDA it is the most critical part of planning and conducting a meeting. A clear and concise idea of why one would attend a meeting is necessary. The other criteria have a narrower value range, up to +/−1.

The PREPARATIONS criterion is an often mentioned issue in formulating an effective meeting. Preparations include things like inviting the right people, sending out the agenda in advance, etc. It is still possible to have a great meeting without a lot of preparation, but putting in time before the meeting pays huge dividends.

THE PROCESS criterion is one that some people might think is the most critical part of any meeting. It is important because working through the objectives and getting to meaningful outcomes serves the meeting attendees and the organizers. The reason this is not valued more than the other criteria is that if there is not a clear goal and a manageable, focused agenda, a meeting is more likely to suffer. And if there is not sufficient preparation, the process, as well, will be affected.

THE OUTCOMES criterion is also quite important. There is no point in having a meeting unless there are useful and measurable outcomes. Purely informational meetings have outcomes—attendees become informed about particular technical, business, political or social issues. That doesn't mean that everyone should leave the meeting with a crushing load of action items. But if your goal for the meeting was clear, and you achieved it, there will likely be things to be done afterward.

THE KEYS button explains in detail the criteria of GOAL+AGENDA, PREPARATIONS, PROCESS AND OUTCOMES. Selecting the Keys button summons a pop-up box including text, audio or video explaining each criterion described above.

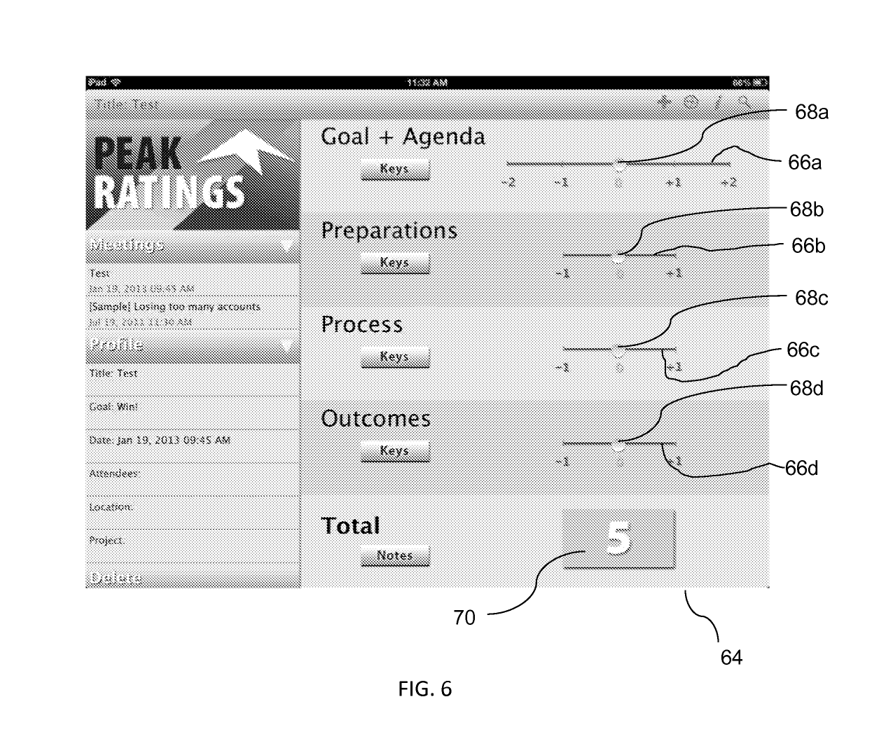

FIG. 6 shows the user interface screen 64 in an initial configuration. When the screen 64 is initialized, the indicators 68a, 68b, 68c, and 68d are pre-set at the value zero (0). The screen 64 includes an indicator 70 revealing an aggregate value. The aggregate value of the indicator 70 when the user interface screen 64 is in the initial configuration is five (5). This is a pre-determined base-line value. It indicates an average meeting based on each criterion having an initial value, which is zero (0), meaning essentially that until a meeting is adjudged to be either superior or inferior on any of the criteria, the meeting is just average.

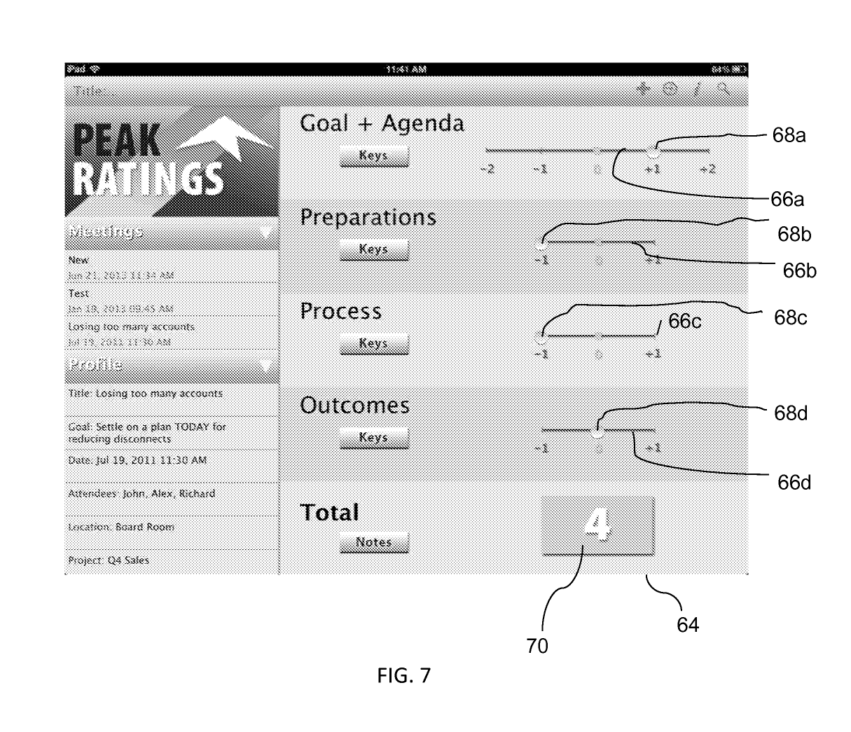

FIG. 7 shows the user interface screen 64 in an adjusted configuration. In response to a user, the indicator 68a is set to +1, indicating the GOAL+AGENDA are better than average. The indicator 68b is set to −1 by the user, indicating that the PREPARATIONS were less than average. The indicator 68c is set by the user to −1 indicating the PROCESS was also less than average. The indicator 68d is unchanged and set at zero (0), indicating that the OUTCOME was average in the subjective view of the user. Accordingly, the numerical values indicated by the indicators 68a, 68b, 68c, and 68d are summed with the baseline value which is the value five (5), yields an aggregate value of four (4), shown by the indicator 70.

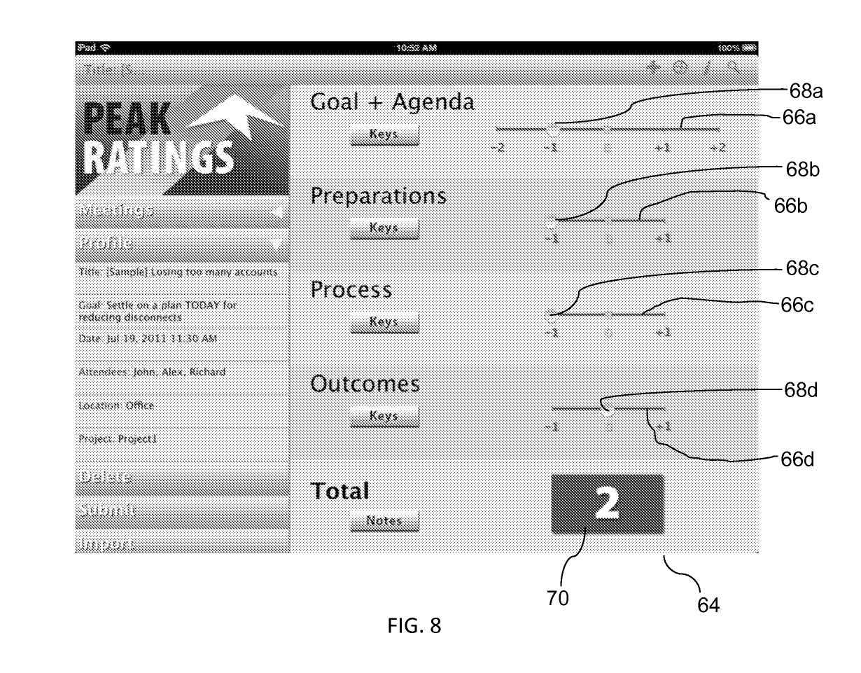

FIG. 8 shows the user interface screen 64 in an adjusted configuration. In response to a user, the indicator 68a is set to −1, indicating the GOAL+AGENDA are less than average. The indicator 68b is set to −1 by the user, indicating that the PREPARATIONS were less than average. The indicator 68c is set by the user to −1 indicating the PROCESS was also less than average. The indicator 68d is unchanged and set at zero (0), indicating that the OUTCOME was average in the subjective view of the user. Accordingly, the numerical values indicated by the indicators 68a, 68b, 68c, and 68d are summed with the baseline value which is the value five (5), yields an aggregate value of two (2), shown by the indicator 70. The aggregate value of two (2) indicates that the meeting was much less useful than an average meeting.

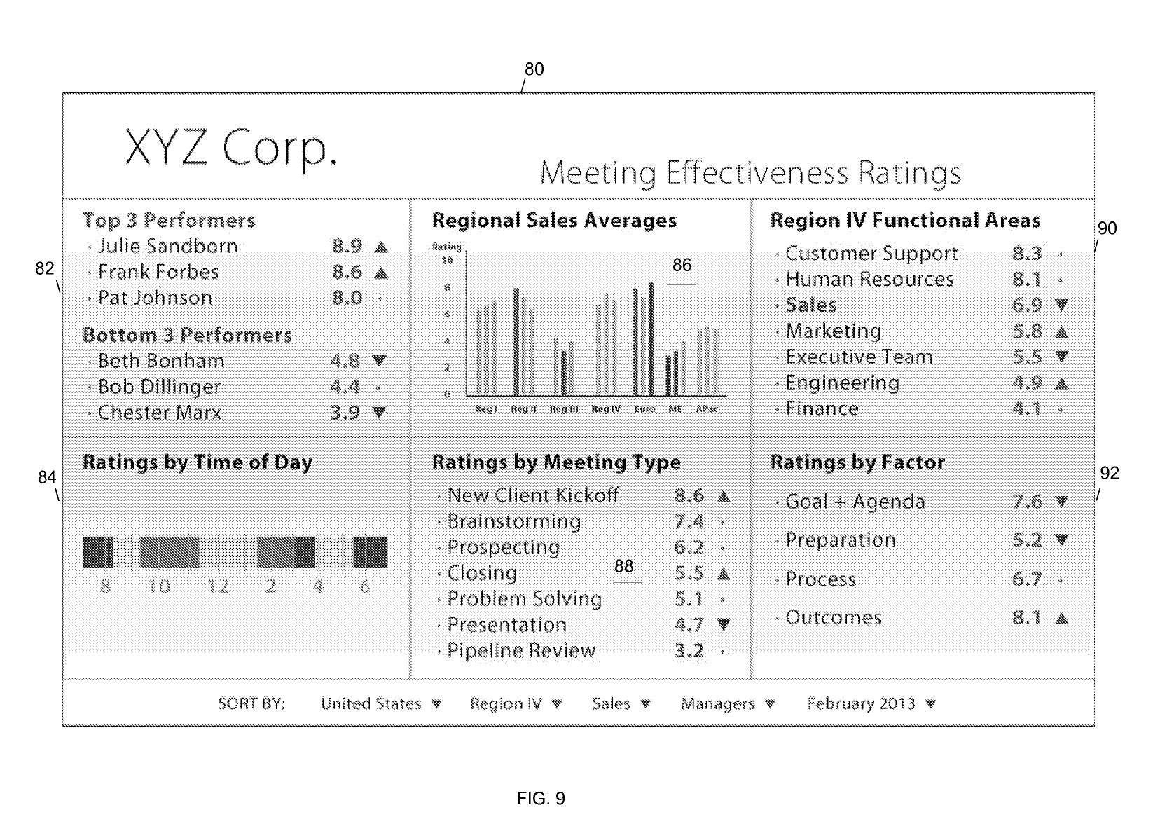

FIG. 9 shows a dashboard in accordance with the present invention, generally indicated by the reference numeral 80. The dashboard enables the display of various custom and pre-programmed reports. As shown there are six pre-programmed report overviews (overviews) displayed in the dashboard. The reports are represented by overviews of the report data, but it can be appreciated that the overviews can also be represented and displayed as graphic icons.

The overviews are presented in a matrix as shown, and the matrix is fixed on the display. Selecting any particular overview reveals additional detail about the content of the selected overview. The additional detail can be presented in a spreadsheet, or any downloadable file format including PDF file format.

The overviews include a performance section 82, a time of day section 84, a regional section 86, a meeting type section 88, a functional area section 90, and a factor section 92.

The performance section 82 includes a list of meeting leaders. For each leader, the average meeting rating is displayed. The quantitative data is the name of each leader. The qualitative data is the rating of the meetings. Further quantitative data is derived by compilation of the qualitative data, and trends thereof

Average meeting ratings above a threshold value (e.g. 7) are indicated by a color, i.e. green, and average meeting ratings below a threshold value (e.g. 5) are indicated by a color, i.e. red. Meeting ratings between the threshold values (e.g. 5-7) are indicated in grey.

Additionally, the increase or decrease in average ratings over a pre-determined period (e.g. a month) are indicated by a carrot that faces upward where there is an increase, and a carrot that faces downward where there is a decrease.

The performance section 82 thus enables a comparison of meeting leaders' performance over a pre-determined period, such as a month, or a year. The period can be programmed by software, or customized by a user.

The performance section 84 is a compilation of meeting times and ratings. The time of day is a piece of quantitative data, and the rating is qualitative data. Accordingly, the effect of times of day on the qualitative data can be analyzed and readily used.

The performance section 86 is regionally based and presented in graphical form as a bar graph with the colors indicated in the performance section 86 using the same threshold values as the performance section 86. The quantitative data includes regions and time frames, and the qualitative data includes the ratings for particular meetings and the compilation thereof. Graphical form is useful to enable a user to quickly evaluate the efficacy of meetings in a particular region that is either pre-defined by software or customized by a user.

The performance section 88 provides a list of meeting types and the ratings of each meeting type. Data from this section 88 can be useful to guide meeting leaders towards possible improvement in particular meeting types, or possible suggestions regarding which meeting types to increase and reduce frequency of particular meeting types.

The performance section 90 lists functional areas and the efficacy of meeting types by functional area. Each functional area is quantitative data. This is combined with the ratings, which are qualitative data. The data from this section 90 can be used by management teams to determine which functional area meetings need to be improved.

The performance section 92 displays an overview of the meeting ratings over a pre-determined period by factors taken from the ratings evaluation screens in the FIGS. 5-8.

The dashboard 80 can be used by numerous people in any organization. Various examples, follow:

### EXAMPLE 1

### Use by a Meeting Participant

At the end of a meeting, a participant can use the Ratings feature of the application to provide a qualitative rating of how they felt the meeting went. In as little as 10 seconds, they can provide feedback on four key factors—the Goal & Agenda, the Preparations, the Process of the meeting itself, and the Outcomes generated from the meeting.

The rating derived, from a range of 0 to 10 (with 10 being highest), gives that individual's ranking, as well as indicating how the person felt about each of the elements, either positive or negative. It's not required, but a user can also provide specific comments about any or all of the four factors. The comments can be read mechanically by the client workstation and qualitative criteria can be derived from the comments. Appropriate algorithms for extracting data from free text are commonly known.

The ratings by each participant are averaged to provide an overall score for the meeting, along with indications, and perhaps specific feedback, about where the meeting was strong and where it was weak.

### EXAMPLE 2

### Use by a Meeting Leader

The aggregate score gives an immediate indication of what went well in the meeting and what could have been better. Due to the timeliness of the feedback, it's even possible to correct issues or errors before everyone leaves the room, thus improving the effectiveness of the meeting.

Ratings for a given meeting are qualitative data that can be combined with other qualitative data, as well as quantitative data associated with the meeting leader to enable assessment of the meeting leader's overall performance. The ratings for a given meeting can also help assess the performance and skill of a team, department, or any other entity of which the meeting leader is a part.

These aggregated ratings, as displayed in a ratings dashboard, become incredibly useful tools for managers, teams, and senior management to assess the on-going effectiveness of an individual, a team, or even the company as a whole. Due to the frequency with which new ratings are generated (since meetings are so pervasive in business today), there can be multiple points of feedback every day. Contrasting this with an annual performance review or a 360-feedback review is like comparing real-time HD video to the snapshot quality of old photographs.

### EXAMPLE 3

### Use by a Manager

The ratings provide a tool with which a manager can quickly and regularly track the quality of effort of staff. Exceptional results can be acknowledged promptly, and mediocre-to-negative results can be addressed immediately. Being able to adjust efforts so quickly provides a significant boost to the effectiveness of a team, since it helps keep everyone working toward the same objective in the most effective and supportive way possible.

As well, the ratings provide important trend data for a manager when it's time to conduct performance reviews. Areas of strength are quickly apparent, and aspects that need further work are also very obvious. Beyond the ratings themselves and one's skills at planning and conducting meetings, the ratings reveal skills of communication, planning, interpersonal skills, capacity to produce desired work, and more.

### EXAMPLE 4

### By an HR Professional

Training in areas like communications, interpersonal skills, planning, time management, and the Getting Things Done methodology can be better focused to the needs of each individual, thanks to the feedback loop of regular meetings. This should lead to even more effective training results and perhaps a reduction in training needs in certain areas, due to the frequency and consistency of feedback. This methodology makes it easy to track someone's progress over time.

In addition, it's possible to recognize troubled situations or struggling employees much more quickly than is currently available. If ratings for a particular group suddenly fall sharply, it's clear that something is wrong that probably needs to be addressed. And if a given employee gives consistently low ratings to meetings, while the other attendees give higher ratings, that can be an early indicator of possible issues around that employee. Being able to intervene before situations become more stressful or counter-productive can be invaluable to a company.

### EXAMPLE 5

### By a Senior Executive

For all the aspects of business that have been measured and exhaustively analyzed, the quality and effectiveness of meetings have never been examined. The reason: there have been no simple, repeatable methods for examining how meetings are conducted, nor the results those meetings do or don't achieve.

With this new approach, executives can track how individuals, groups, and even divisions are doing in near-real time. And they can quickly examine, with a customized digital dashboard, trend data comparing meeting results across dozens of factors. They can look at analyses on a company-wide macro level. On a micro level, companies can drill down to see the progressive trends of meeting performance by an individual meeting host, such as a key manager.

The insights garnered by this method can improve executive development, resource planning and deployment, product development, budgeting, and decisions about hiring and firing.

And when customers are included in the process of rating meetings with staff, critical feedback is quickly and easily captured, feedback that can change how the company interacts with its customers and constituents.

The description above is intended to be exemplary in nature and not limiting of the invention. The full scope of the invention is defined by the appended claims.

1. A method of rating a meeting using qualitative data, comprising:
providing an electronic device having a processor, memory, a network interface and a user interface, in operable communication with the processor, the electronic device being programmed with software for enabling a meeting;
conducting the meeting;
displaying a set of evaluation criteria on the user interface, including displaying a slider bar for each criteria, the slider bar being labeled with indicia having a value;
displaying an indicator on each slider bar, and selecting a value on each slider bar;
summing the selected values for each slider bar to determining an aggregate value; and
rating the meeting using the aggregate value.

2. The method as set forth in claim 1, wherein the electronic device includes software having meeting templates, guides, and other structuring elements in the software that provide the foundation for planning, conducting, and following up on the rated meeting, the step of displaying a set of evaluation criteria and the step of rating the meeting are enabled by the software.

3. The method as set forth in claim 1, wherein the step of rating the meeting includes combining the rating with quantitative data and displaying the combined data on a dashboard.

4. The method as set forth in claim 1, wherein the step of conducting the meeting includes networking numerous electronic devices and displaying text, images and sound on the numerous devices.

5. The method as set forth in claim 1, wherein the step of displaying a set of evaluation criteria on the user interface includes displaying evaluation criteria selected from the group consisting of:
Goal and Agenda; Preparations; Process; and Outcomes.

6. The method as set forth in claim 1, wherein the step of displaying a set of evaluation criteria on the user interface includes displaying a slider bar for each of:
Goal and Agenda; Preparations; Process; and Outcomes.

7. The method as set forth in claim 1, wherein the step of displaying a slider bar includes displaying a numeric value ranging from −2 to +2 for at least one slider bar.

8. The method as set forth in claim 1, wherein the step of displaying a slider bar includes displaying a numeric value ranging from −1 to +1 for at least one slider bar.

9. The method as set forth in claim 1, wherein the step of summing the values includes displaying the aggregate value, the aggregate value is determined by establishing a base value and modifying the base value using the selected values.

10. The method as set forth in claim 9, wherein the base value is five (5).

11. The method as set forth in claim 1, wherein the step of rating the meeting includes comparing the aggregate value with a historical average aggregate value.

12. The method as set forth in claim 2, wherein the step of rating the meeting includes quantitative data selected from the group consisting of: meeting duration, time of day, time of year and the number of attendees.

13. The method as set forth in claim 12, wherein the quantitative data is extracted from the calendar.

14. An electronic device for rating a meeting using qualitative data, comprising:
a processor;
a memory, a network interface and a user interface in operable communication with the processor, the electronic device being programmed with software; the electronic device being programmed with the software to perform the steps of:
scheduling a meeting including a list of attendees;
after scheduling the meeting, displaying a set of evaluation criteria on the user interface, including displaying a slider bar for each criteria, the slider bar being labeled with indicia having a value;
displaying a sliding indicator on each slider bar, and selecting a value on each slider bar;
summing the selected values for each slider bar to determining an aggregate value; and
rating the meeting using the aggregate value.

15. The device as set forth in claim 14, wherein the software includes a calendar, templates, guides, and other structuring elements, the step of displaying a set of evaluation criteria and the step of rating the meeting are enabled by the software.

16. The device as set forth in claim 14, wherein the electronic device includes speakers and a touch screen interface or computer mouse, step of conducting the meeting includes displaying text, images and sound on the electronic device.

17. The device as set forth in claim 16, wherein the network interface enables conducting a meeting via a digital network.

18. The device as set forth in claim 16, wherein the set of evaluation criteria are selected from the group consisting of:
Goal and Agenda; Preparations; Process; and Outcomes.

19. The device as set forth in claim 18, wherein the sliding the indicator on the slider bar selects a value for each evaluation criteria.

20. The device as set forth in claim 18, wherein at least one slider bar includes a numeric value ranging from −2 to +2.
